(19) United States
(12) Patent Application Publication
(10) Pub. No.: US 2019/0019533 A1
(43) Pub. Date: Jan. 17, 2019

(54) METHODS FOR EFFICIENT ANNOTATION OF AUDIOVISUAL MEDIA

(71) Applicant: Mashlink, Inc., Beverly (GB)

(72) Inventors: Justin Kaufman, Sedattle, WA (US); Erich Archer, Beverly, MA (US); Stuart Foulston, Woodbridge (GB)

(73) Assignee: Mashlink, Inc., Beverly (GB)

(21) Appl. No.: 16/035,611

(22) Filed: Jul. 14, 2018

Related U.S. Application Data
(60) Provisional application No. 62/533,544, filed on Jul. 17, 2017.

(51) Int. Cl. G11B 27/031; H04N 21/8547; H04N 21/81

(52) U.S. Cl. CPC G11B 27/031; H04N 21/8126; H04N 21/8547

(57) ABSTRACT

Disclosed herein are embodiments of the invention which allow for creating an audiovisual media project based on a primary audiovisual file and a secondary audiovisual file captured using a user's mobile device. This secondary audiovisual file allows for a user to annotate the primary audiovisual file with the user's own commentary in the form of the secondary audiovisual file. The user may annotate the primary audiovisual file at any point during the duration of the primary audiovisual file, and in this manner, another user may view the primary audiovisual file, encountering playback of secondary audiovisual media throughout the primary audiovisual file. Embodiments of the invention also allow for the adding of supplementary effects, editing the content of secondary audiovisual files as well as the position or playback times of the secondary audiovisual files relative to the playback timeline of the primary audiovisual timeline.

### PRIORITY CLAIM

This application claims the benefit of co-pending provisional patent application No. 62/533,544, file priority date of Jul. 17, 2017 which is incorporated by reference as if fully set forth herein.

### BACKGROUND

### Field of Invention

Embodiments of the present disclosure relate generally to methods for altering audiovisual media, and more specifically to creating and annotating a primary audiovisual media with a secondary audiovisual content from a user device and distributing of annotated audiovisual content.

### Description of Related Art

Methods, devices and software currently exist that may enable users to edit media and insert or remove audiovisual content. Products such as Adobe Premiere™ and Apple Final Cut Pro™ are examples of software that allow for local editing. Additionally, websites such as YouTube™, Vimeo™ and other video audiovisual services allow for uploading of audiovisual content that may be later streamed. Instagram™ allows for still-image as well as audiovisual production and distribution process for its users.

### SUMMARY

Embodiments of the invention include a server-side playback script, and client-side audiovisual (A/V) presentation and editing engines. Embodiments of the invention include the storing of presentations on a user's mobile device as well as synchronization with private, online user accounts. In further embodiments, these presentations may be, at the user's request, exported and shared publicly on third party Internet-enabled desktop and mobile applications. When a presentation is requested by the user, the presentation engine retrieves and parses the playback script associated with the requested presentation from the server. Embodiments of the invention provide advantages over related art in that a user's audiovisual commentary on other audiovisual content may be inserted, edited and uploaded at the user's direction, all within a single software product on a user's mobile device. In this manner, the user may avoid the arduous and time-intensive process of obtaining video files, recording commentary, transferring files between devices, and editing the videos using software that is designed for industry professionals.

### BRIEF DESCRIPTION OF THE DRAWINGS

FIG. 1 shows a functional block diagram of a client server system that may be employed for some embodiments according of the present disclosure;

FIG. 2 illustrates a menu for audiovisual annotation on a mobile device, according to embodiments of the present disclosure;

FIG. 3 illustrates an audiovisual annotation overlaid on media content, according to embodiments of the present disclosure;

FIGS. 4A, 4B and 4C illustrate a method for operation of a presentation engine that presents primary audiovisual media, according to embodiments of the present disclosure;

FIGS. 5A, 5B and 5C illustrate a method for operation of a presentation engine that presents secondary audiovisual media, according to embodiments of the present disclosure;

FIGS. 6A, 6B and 6C illustrate a method for operation of a secondary audiovisual media capture engine, according to embodiments of the present disclosure;

FIGS. 7A, 7B and 7C illustrate a method for operation of a secondary audiovisual media editing engine, according to embodiments of the present disclosure; and,

FIGS. 8A and 8B illustrate a method for operation of a audiovisual media composition engine, according to embodiments of the present disclosure.

### DETAILED DESCRIPTION

### Generality of Invention

This application should be read in the most general possible form. This includes, without limitation, the following:

References to specific techniques include alternative and more general techniques, especially when discussing aspects of the invention, or how the embodiment might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicon

“Audiovisual content” (also referred to herein as: “A/V content,” “A/V media” or simply “A/V”) may refer to media that contains one or more of: audio, still photographic and/or motion video content. Both audio content and video content may be synchronized in a manner such that what appears in the video content may also be heard in the audio content. Furthermore, audiovisual content may also contain captions containing a transcript of speech spoken in the audio content associated with the audiovisual content, as well as other visual effects such as animated drawings and graphics.

“Presentation” or “project file” may refer to a compilation or composition or compositing of one or more of the following but not limited to: primary A/V, secondary A/V, timeline array, transcript array, closed captions, supplementary effects or any other media described herein. In one embodiment, the project file may refer to a set of data structures associated with a project. Said data structures may be serialized (i.e., persisted) to a database. This database may be local to a user's device, thus the database may only contain data for users that have used the app on that particular device. When synchronized with the Cloud, data from all users may ultimately be aggregated into a third party database.

“Compositing” or “compilation” or “composition” may refer to the execution of computational processing of one or more of the following: primary A/V, secondary A/V, supplementary effects, and/or any other effects or media as described herein.

“Primary audiovisual content” or “primary A/V” may refer to media uploaded for others to view, share, edit and annotate. Primary A/V may be found on public websites such as YouTube™. Primary A/V may also refer to media added by a user that has yet to be made public, (e.g., as media recorded with a user's device's camera or imported from a mobile device video library). In addition, primary audiovisual content may have a video-in timestamp and a video-out timestamp that specify the portion of the primary audiovisual content that may be intended to be included in the exported presentation.

“Secondary audiovisual content” or “secondary A/V” may refer to A/V content added directly to the app, such as media recorded directly with the device's camera or imported from the device's video library. One or more secondary audiovisual content may be associated with one or more primary audiovisual content.

An “annotation” may refer to the insertion of one or more of, but not limited to: secondary audiovisual content, visual effects, supplementary effects, and/or closed captioned content representing a transcript of the secondary audio content. In addition, an annotation may have a comment-in time stamp representing the time at which that annotation should begin within the primary audiovisual content, as well as other user-specified options relating to the presentation of that annotation in the context of the primary audiovisual content, such as defining specific animation styles for the presentation or dismissal of an annotation video frame, or a synchronicity flag that indicates whether or not a primary video should continue playing for the playback duration of an annotation.

A “timeline array” may refer to the timeline through which primary audiovisual content elapses. For example, the beginning of a timeline array may indicate the beginning of primary audiovisual content, and the end of a timeline array may indicate the ending of primary audiovisual content. As described herein, a timeline array may take the form of metadata associated with one or more primary or secondary A/V, and said metadata may include timestamps as described herein. In some embodiments, a timeline array is a visual description of metadata associated with either primary or secondary A/V. In this manner, playback of either primary or secondary A/V in relation to each other may occur in the order a user choses. By way of example and not limitation, said metadata may include comment-in and comment-out timestamps or start and stop times of secondary A/V relative to primary A/V.

A “comment-in timestamp” may refer to the position on a timeline array when secondary audiovisual content may begin.

A “comment-out timestamp” may refer to the position on a timeline array when secondary audiovisual content may end.

A “transcript array” may contain temporal locations of transcripts of speech generated in secondary audio content. For example, audio content from secondary audiovisual content may contain speech spoken by a user which is then fed through a transcription engine and processed into text. The text may be displayed as closed captions on a user's screens. Secondary audio playback may be associated with a user's speech, and thus captions of transcripts of the user's speech may be synchronized with secondary audio playback in a manner conducive to a user's ease of viewing and listening of content. Thus, a transcript array may contain temporal locations (timestamps) of transcripts synchronized to secondary audio.

“Supplementary effects” may refer to image filters, digital stickers, animations, animated emoji, transition animation or any other effects known in the art. Secondary effects may include but are not limited to:

(1) Image or video filters (e.g., as used in Instagram™) applied to either primary or secondary A/V. For example, a ‘sepia’ filter may be applied to the secondary A/V to give the secondary A/V a more ‘natural’ tone. Filters may boost/warm color tones to make a scene appear in a summery/exotic environment, or make a scene appear hand-drawn/painted.

(2) Insertion of static/animated text over primary A/V and/or secondary A/V. In one embodiment, said text may be typed using a mobile device keyboard. Said text may be alterable, repositionable, scaleable up/down, rotatable, animatable, (i.e., such as allowing text to fade in/out at specific times (e.g., at comment-in/out timestamps)) with different appearance/disappearance effects, or position-animated over time.

(3) Insertion of static/animated images over primary/secondary A/V. In some embodiments, images may be emoji, images from the user's photo library, or from third parties such as sticker packs or alternative keyboards (e.g. “Bitmoji”). Static/animated images may be editable/animatable similarly to the text effects described above.

(4) Insertion of drawings/markings which may mimick art as if done with a pen/pencil. In this manner, multiple different pen colors/styles/effects may be specifiable by a user. Said drawings/markings may fade out automatically after a specified time, or cleared at some other time specified by the user. Said drawings/markings may be drawn directly over the content by a user with their finger, or using a stylus (e.g. Apple Pencil). This type of supplementary effect may be likened to the way sports pundits draw markings over images/videos of sports games to draw viewer attention to player positions/tactics etc.

(5) Editing of primary A/V for the duration of a specific annotation. For example, playback speed of the primary video is slowed down. To support the complexity of adding numerous supplementary effects, the inventors envision implementing a “layering” system (e.g., such as that in an Adobe Photoshop™ or OmniGraffle™ file), such that the effects can be manipulated in isolation of each other, but combined when previewing/compositing the presentation.

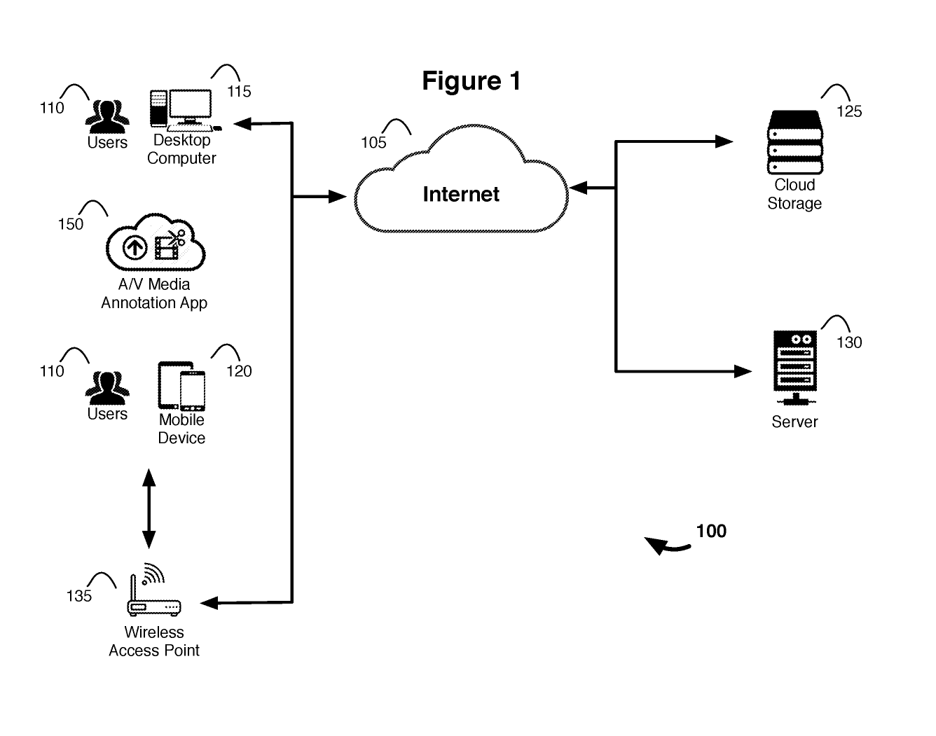

### FIG. 1

### Processing System

The methods and techniques described herein may be performed on a processor-based device. The processor based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventors contemplate that the methods disclosed herein will also operate over a network such as the Internet, and may be effectuated using combinations of several processing devices, memories and I/O. Moreover any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality. Alternatively the entire processing system may be self-contained on a single device.

In general, the routines executed to implement the current disclosure, may be implemented as part of an operating system or a specific application, component, program, object, module or sequence of instructions referred to as “computer programs,” apps, widgets, and the like. The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments are capable of being distributed as a program product in a variety of forms, and that the current disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

### Client-Server Processing

FIG. 1 shows a functional block diagram of a client server system 100 that may be employed for some embodiments according to the current disclosure. In FIG. 1, one or more servers such as server 130 are coupled to a database such as cloud storage 125 and to a network such as Internet 105. The network may include routers, hubs and other equipment to effectuate communications between all associated devices. A user 110 may access server 130 by a computer 115 communicably coupled to Internet 105. The computer 115 may include a sound capture device such as a microphone (not shown). Alternatively the user may access server 130 through Internet 105 by using mobile device 120. By way of example and not limitation, mobile device 120 may be a smartphone, PDA, or tablet PCs, however the inventors envision any and all means of computing devices. Mobile device 120 may connect to server 130 through an access point 135 coupled to Internet 105. Mobile device 120 may include a sound capture device such as a microphone (not shown).

Conventionally, client-server processing operates by dividing the processing between two devices such as server 130 and a smart device such as mobile device 120. The workload is divided between the servers and the clients according to a predetermined specification. For example in a “light client” application, the server does most of the data processing and the client does a minimal amount of processing, often merely displaying the result of processing performed on a server.

In some embodiments, client-server applications may be structured so that the server provides machine-readable instructions to the client device and the client device executes those instructions. The interaction between the server and client may indicate which instructions are transmitted and executed. In addition, the client may, at times, provide for machine readable instructions to the server, which in turn may execute them. Several forms of machine readable instructions are conventionally known, including applets, and may be written in a variety of languages, by way of example and not limitation: Java and JavaScript.

Client-server applications also provide for software as a service (SaaS) applications where the server may provide software to the client on an as-needed basis.

In addition to the transmission of instructions, client-server applications may also include transmission of data between the client and server. Often this entails data the may be stored on the client to be transmitted to the server for processing. The resulting data may then transmitted back to the client for display or further processing.

One having skill in the art will recognize that client devices may be communicably coupled to a variety of other devices and systems such that the client receives data directly and operates on that data before transmitting it to other devices or servers. Thus data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein a display engine, a data engine, an execution engine, a user interface (UI) engine, a promo engine, a sentiment engine, and the like may be employed. These engines may seek and gather information about events from remote data sources and control functionality locally and remotely.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

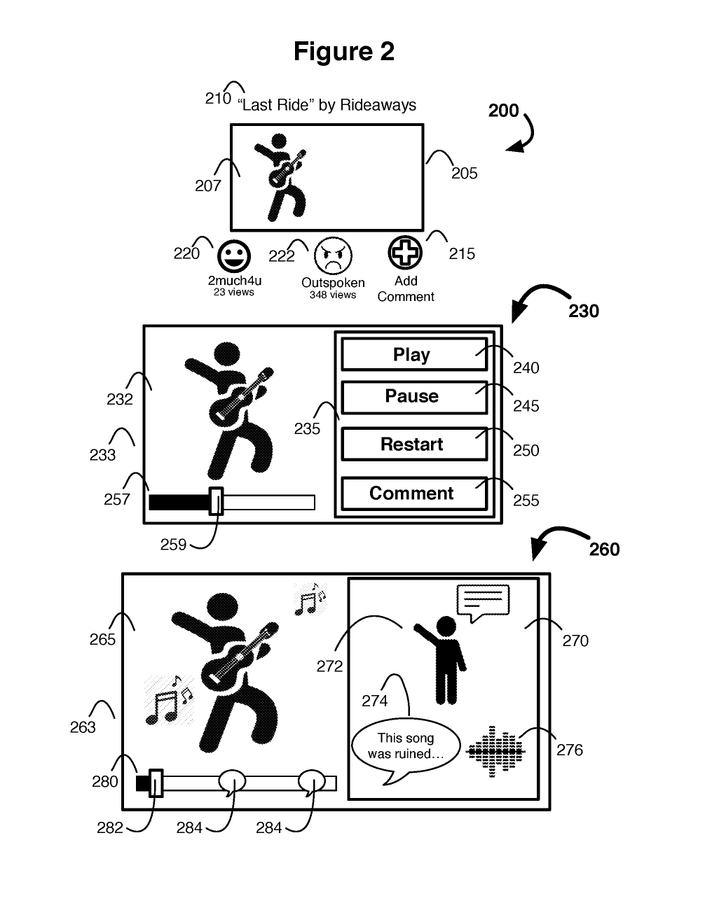

### FIG. 2

FIG. 2 illustrates a menu to allow for a user to annotate primary audiovisual content with secondary audiovisual content on a mobile device, according to embodiments of the present disclosure. Display 200 may show a primary video frame 205 playing content 207. Primary video frame 205 may be capable of displaying audiovisual content (such as content 207) from any compatible Internet-based source. Title 210 may show the title of content 207. By way of example and not limitation, content 207 is shown as a song titled “Last Ride by Rideaways,” which is a music video performance with musicians displayed on the user's screen on primary video frame 205. In some embodiments, transcripts or equalizer bars (not shown) related to the primary audio content may be provided in display 200. Display 200 may also show ‘add comment’ button 215. In one embodiment, ‘add comment’ button 215 may allow a user to annotate primary audiovisual content. These annotations may take the form of secondary audiovisual content.

Embodiments of the invention may also provide for user accounts and avatars. For example, user avatars 220 and 222 may be associated with view counts and may be located, by way of example and not limitation, below content 207. In some embodiments, this location and view count may indicate that these users have annotated content 207 or primary audiovisual media. User avatars may have associated information that allow for users to observe, by way of example and not limitation: users' status, users' annotation view count, and popularity rating. While these indicia are provided, any and all avatar statuses or user account information known in the art is contemplated by the inventors. In further embodiments, a view count of one or more of the following is provided: primary audiovisual content, secondary audiovisual content, annotations or captions.

Embodiments of the invention may allow for submenu 235 to display options for playback and annotation, as shown in display 230 and primary video frame 233. Display 230 may be similar to display 200 with some elements removed for clarity. Display 230 may display options for a user to play content 232 or add their own annotations to content 232 using submenu 235. In some embodiments, content 232 may include primary audiovisual content or content 207. In further embodiments, content 232 may also contain secondary audiovisual content, supplementary effects, transcripts from one or more users' annotations or any other media as described herein. In some embodiments, the inventors envision multiple users annotating (i.e., associating secondary A/V) to one or more primary A/V).

Submenu 235 shows, by way of example and not limitation, 4 options: “Play,” “Restart,” “Share,” and “Comment.” While four options are provided, any and all media playback and editing commands known in the art are contemplated by the inventors. In this manner, a user may select “play” command 240 to play content 232, the “restart” command 245 to replay content 232, “share” command 250 to share primary (and, in some embodiments, the secondary) audiovisual content with others, “comment” command 255 to begin the annotation process, as described herein. While several exemplary commands have been given, the inventors contemplate the use of any and all audio/video commands known in the art.

In one embodiment, the ‘share’ feature of submenu 235 may be used to publish audiovisual content online for others to view. By way of example and not limitation, a user may create a combination (“project file”) of primary and secondary audiovisual media and may share the project file through a chosen app (e.g., Instagram™, Facebook™, etc.).

Scrubber track 257 allows a user to select a playback timestamp to begin playback from using scrubber button 259. In some embodiments, scrubber track 257 may partially change color to indicate to the user at what point playback has elapsed, as shown by the shaded area of scrubber track 257. Furthermore, a countdown indicator or progression indicator showing time elapsed/time remaining (not shown) is contemplated by the inventors for any and all A/V playback described herein. While not shown, the inventors contemplate the use of one or more of: play/pause, fast forward/rewind and any A/V media control buttons known in the art for the use of any and all A/V playback described herein.

Display 260 shows an example of secondary audiovisual content 270 overlaid onto primary audiovisual content 265 in primary video frame 263. In one embodiment, secondary audiovisual content 270 may be an annotation made by a user. By way of example and not limitation, user 272 may be shown speaking in reference to primary audiovisual content 265. In this example, user 272 may be the same user who created the secondary audiovisual content 270. In addition in this example, user 272 may be the operator of the mobile device running embodiments described herein, including one or more displays described in FIG. 2.

Secondary audio content 276 (represented by equalizer bars) from secondary audiovisual content 270 may contain an audio file of user 272's speech. Captions 274 may represent the text of user 272's speech in secondary audio content 276. In one example, user 272's speech may be fed into a transcript engine in order to generate captions 274 on display 260. In another example, user 272's speech may be entered by a user or closed captioning service.

In a further embodiment, secondary or supplementary effects (not shown) may be added to to either/both the primary A/V or secondary A/V. Supplementary effects, as described in the Lexicon portion of this disclosure, as well as elsewhere herein, may appear alongside and/or in sync with primary or secondary A/V. In some embodiments, facial recognition and facial expression processing algorithms may be used to convert a digital representation of a user's face into an animation (e.g., such as Apple's “Animoji”™ and/or “Memoji”™), lending anonymity to a user of embodiments of the present disclosure.

Supplementary effects may be added/edited in a “layered” fashion, akin to ‘layers’ used in photo/video editing software known in the art. In this manner, multiple layers may be combined to form rich and complex secondary A/V. By way of example and not limitation, secondary A/V discussing a paused frame of a physical workout video might use a pen-like tool to circle/highlight specific muscles being activated in the video. Furthering the example, supplementary effects may include inserting smiling/sad emojis as animated stickers to convey whether the video is demonstrating the right/wrong way to do a particular workout. Furthering the example still, secondary A/V may consist of a team sports game, where a pen-like tool may be used to highlight player positions and movements. While some examples of supplementary effects have been provided, these effects are by no means exhaustive, and the inventors contemplate the use of any and all forms of auditory and visual media effects known in the art as possible candidates for supplementary effects.

In a further embodiment, image filter effects may be applied to either primary or secondary A/V. By way of example and not limitation, a ‘sepia’ filter may be applied to the secondary A/V to give the secondary A/V a more ‘natural’ tone. Other filters may boost/warm color tones to make a scene appear in a summery/exotic environment, artistic filters that make a scene appear hand-drawn/painted. While these examples has been given, the inventors contemplate the use of any and all A/V filters and effects known in the art.

In a further embodiment, introduction and dismissal of either the primary or A/V may take various forms. By way of example and not limitation, introduction and/or dismissal of a secondary A/V may take the form of a video frame framing secondary A/V sliding on top of the video frame for a primary A/V. While a sliding animation has been provided, the inventors contemplate the use of any and all A/V transitions known in the art. Furthermore, presentation/dismissal animation styles may represent the way in which a video frame for secondary A/V may be animated on or off a user's screen when that secondary A/V may begin or may end. The available animation styles in which this occurs may depend on other factors, including but not limited to: the dimensions/orientation of the secondary A/V.

In some embodiments, primary audiovisual content 265 may be displayed in 16:9 aspect ratio (e.g., landscape). In other embodiments, secondary audiovisual content 270 may be displayed in 9:16 aspect ratio (e.g., portrait). In further embodiments, secondary audiovisual content 270 may be located anywhere on a display. By way of example and not limitation, secondary audiovisual content 270 may be placed on the left or right border of a user's screen. All aspect ratios, frame positions and screen resolutions for both primary audiovisual content 265 and secondary audiovisual content 270 are contemplated by the inventors.

Scrubber track 280 allows a user to select a playback timestamp to begin playback from using scrubber button 282. In some embodiments, scrubber track 280 may partially change color to indicate to the user at what point playback has elapsed, as shown by the shaded area of scrubber button 282. On scrubber track 280 are two secondary A/V markers 284 illustrated as speech bubbles. Secondary A/V markers 284 may indicate the location of secondary audiovisual content 270. In one embodiment, a user may record audiovisual commentary on a primary A/V timeline, and embodiments of the invention may display the location of the user's secondary A/V relative to the timeline of the primary A/V. In another embodiment, the location of secondary A/V markers 284 indicate the comment-in and comment-out timestamps of secondary A/V.

Furthermore, a countdown indicator or progression indicator showing time elapsed/time remaining (not shown) is contemplated by the inventors for any and all A/V playback described herein. While not explicitly shown, the inventors contemplate the use of one or more of: play/pause, fast forward/rewind and any A/V media control buttons known in the art.

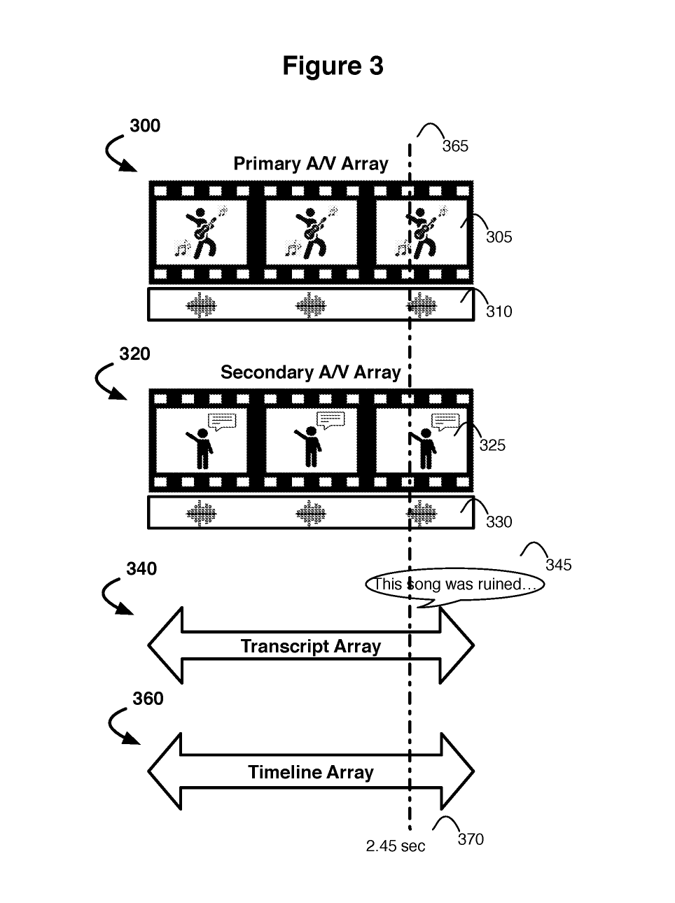

### FIG. 3

FIG. 3 illustrates arrays, according to embodiments of the present disclosure. Primary audiovisual array 300 may show video frames 305 and audio segments 310. In some embodiments, video frames 305 may be synchronized with audio segment 310. Secondary audiovisual array 320 may show video frames 325 and audio segment 330. In some embodiments, video frames 325 may be synchronized with audio segments 330. In further embodiments, one or more of video frames 305, audio segments 310, video frames 325 and audio segments 330 may be synchronized with one or more of each other.

Transcript array 340 may show the temporal locations of transcripts of speech generated in secondary audiovisual array 320. For example, audio content 330 from secondary audiovisual array 320 may contain speech spoken by a user which is then fed through a transcription engine (not shown) and processed into captions 345 as described herein. Captions 345 may be displayed as captions on a user's screen.

By way of example and not limitation, secondary audiovisual array 320 may contain an audiovisual recording of a user's commentary on primary audiovisual array 300. Audio segments 330 (from secondary audiovisual array 320) may be associated with the user's speech, and thus captions 345 of transcripts of the user's speech may be synchronized with secondary audio playback. If a user decides to view primary and secondary audiovisual arrays 300 and 320, such synchronization may be conducive to a user's ease of viewing and listening. Thus a transcript array may contain temporal locations of transcripts matched to secondary audio. Furthermore, timestamps as described herein may be used to synchronize one or more of the following: primary audiovisual array 300, secondary audiovisual array 320, transcript array 340, timeline array 360, supplementary effects, and/or any other A/V material or associated metadata described herein.

Finally, timeline array 360 shows the temporal relationship between transcript array 340, primary audiovisual array 300 and secondary audiovisual array 320. Synchronization line 365 may show the relationship between one or more of the arrays 300, 320, 340 and/or 360 or any array described herein. By way of example and not limitation, synchronization line 365 is set at 2.45 seconds at timeline array marker 370 and displays caption 345. By way of example and not limitation, synchronization line 365 may indicate that a caption (e.g., caption 345) may be associated with metadata indicating that the caption should playback at 2.45 seconds of elapsed time into the primary A/V.

In some embodiments, caption 345 may be similar to caption 274, primary audiovisual content 265 may be similar primary audiovisual array 300, and secondary audiovisual array 320 may be similar to secondary audiovisual content 270.

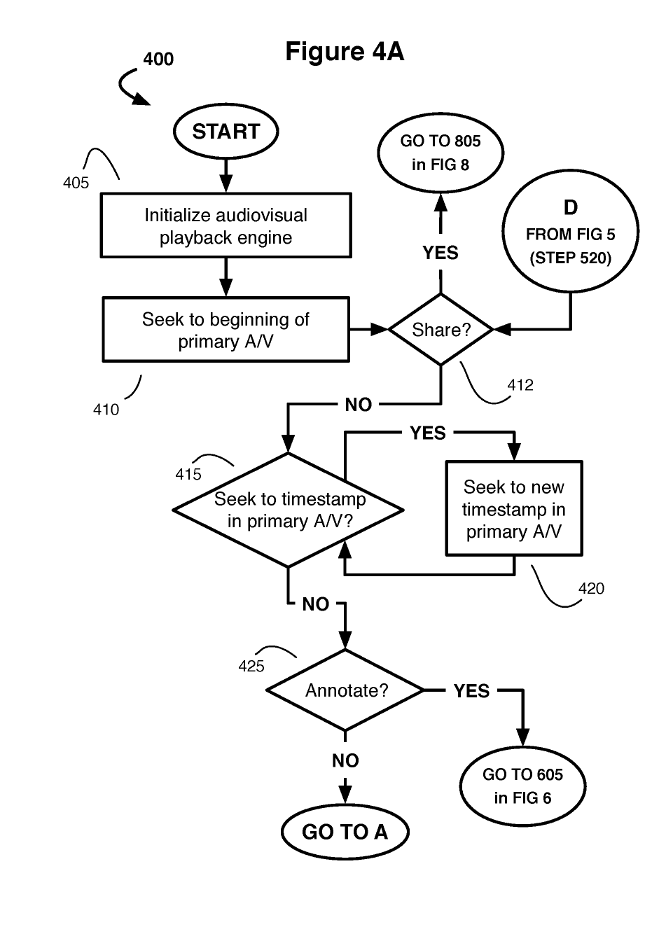

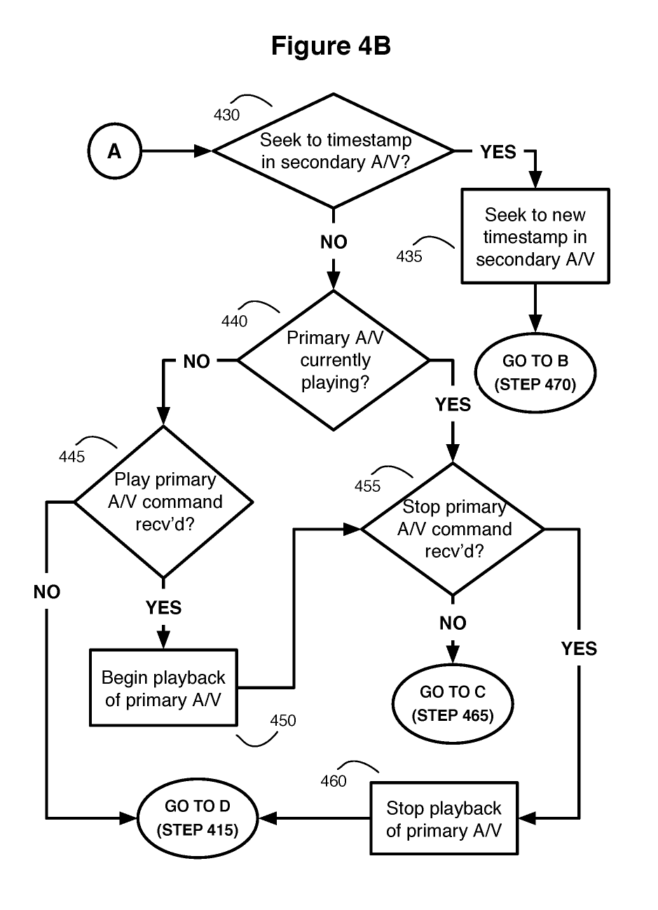

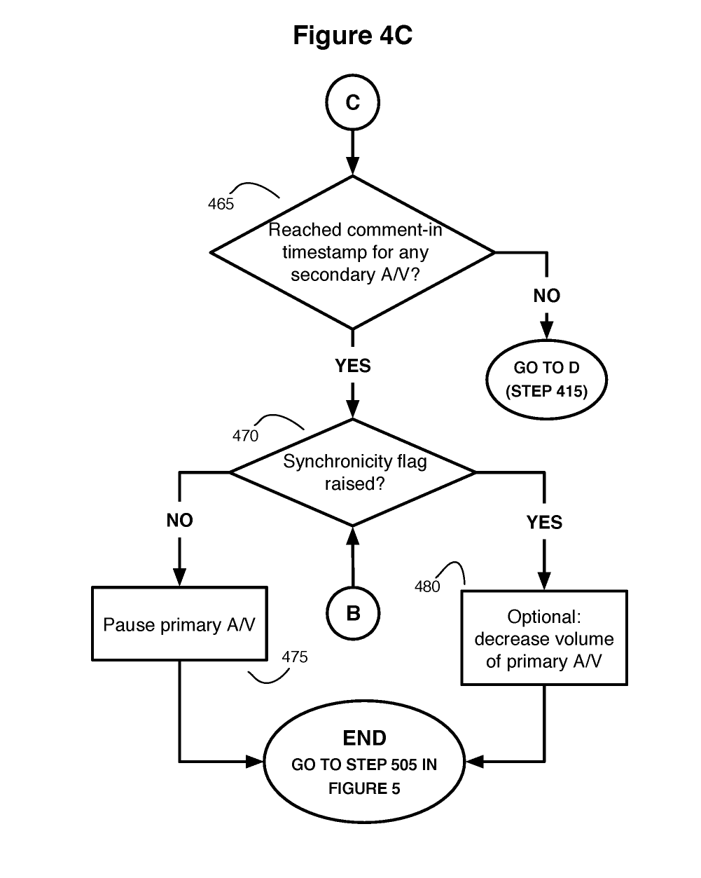

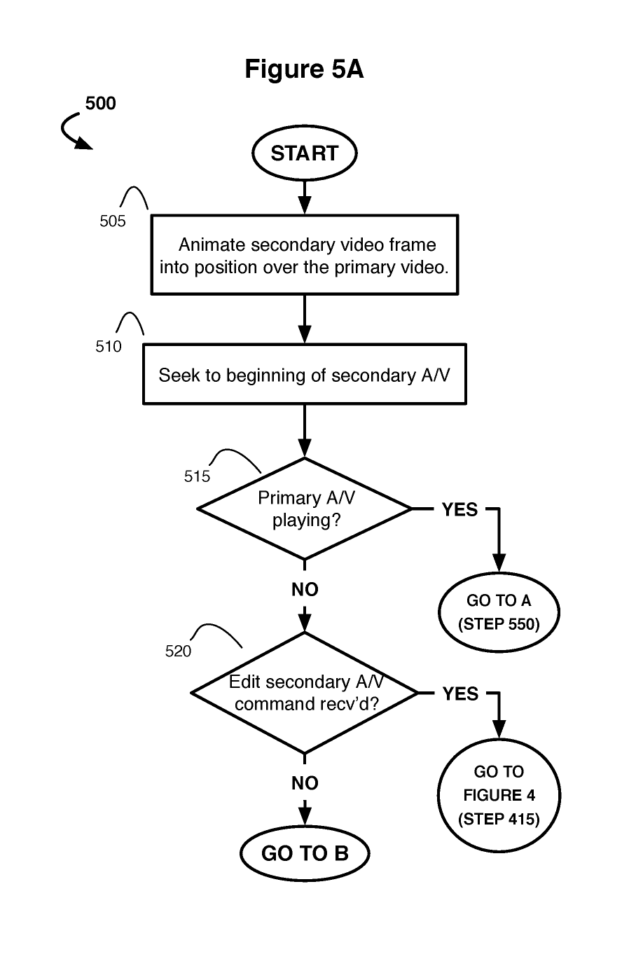

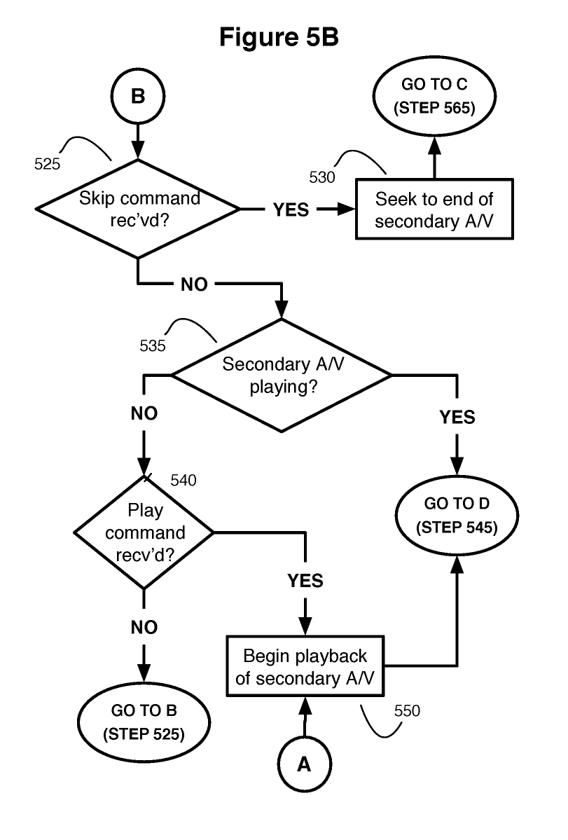

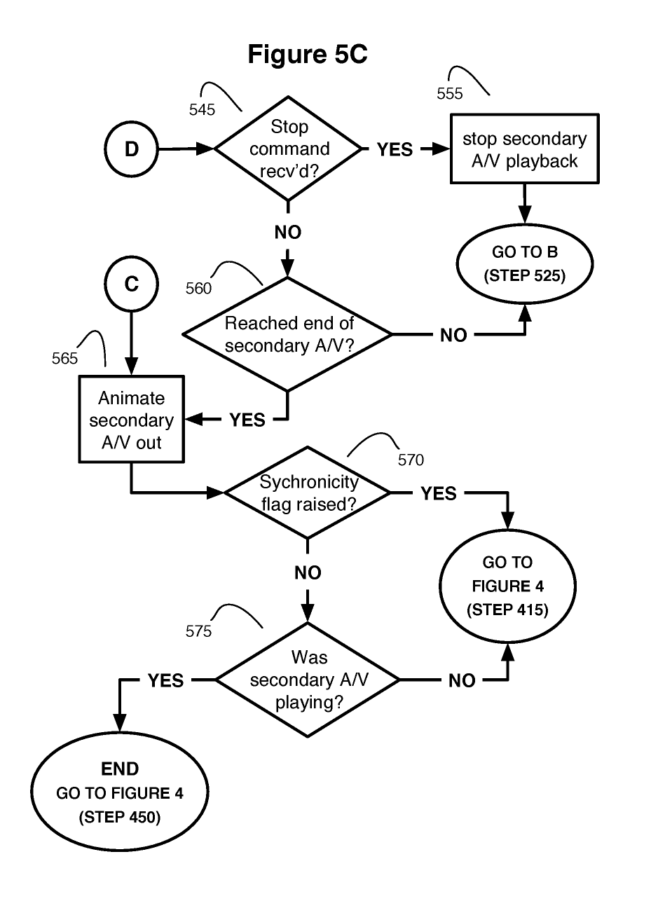

### FIGS. 4A, 4B and 4C: Primary A/V Presentation Engine

FIGS. 4A, 4B and 4C illustrate a method for operation of a presentation engine that presents primary audiovisual media, according to embodiments of the present disclosure. In some embodiments, the presentation engine may execute instructions for playback of primary audiovisual media. Although the method steps are described in conjunction with FIGS. 1-8, persons skilled in the art will understand that any system configured to perform the method steps, even in a different order may fall within the scope of the present disclosure. Moreover, the steps in this method are illustrative only and do not necessary need to be performed in the given order they are presented herein. In some embodiments, certain steps may be omitted completely.

The method 400 may begin with a step 405, in which the audiovisual playback engine may be initialized. In one embodiment, any startup procedures associated with the A/V playback engine may be executed in this step.

At a step 410, the presentation engine may seek to beginning of a primary A/V. At a step 412, a determination may be made as to whether a share command has been recieved. If a share command has been recieved, the method 400 may transition to method 800 and may proceed to a step 805, as described herein. If a share command has not been recieved, the method may proceed to a step 415.

At step 415, a determination may be made as to whether a command has been received to seek to a particular time stamp within the primary A/V file. If a particular time stamp has been sought, the method 400 may proceed to a step 420, in which the playback engine may begin playback from the sought time stamp, after which the method 400 may return to step 415.

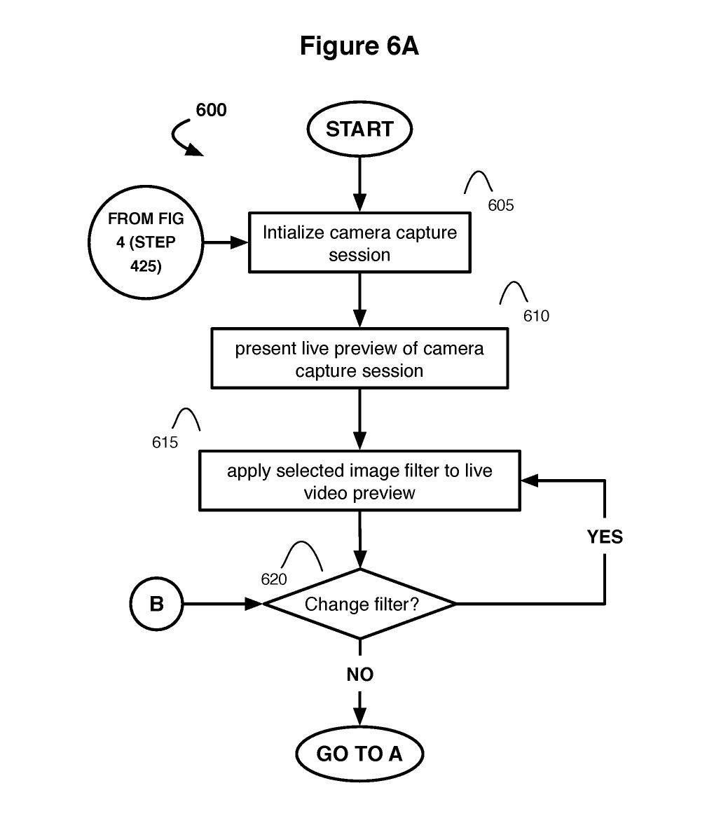

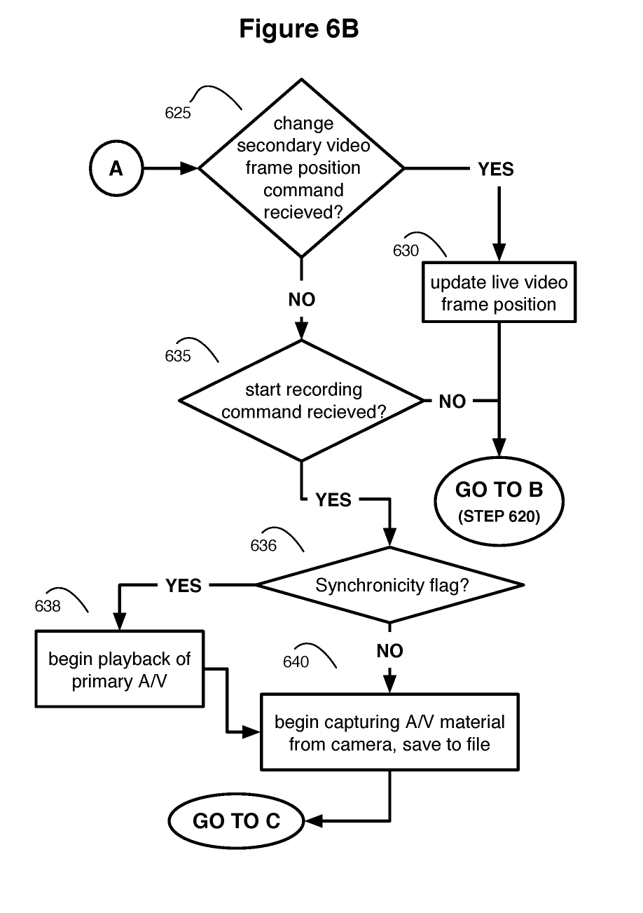

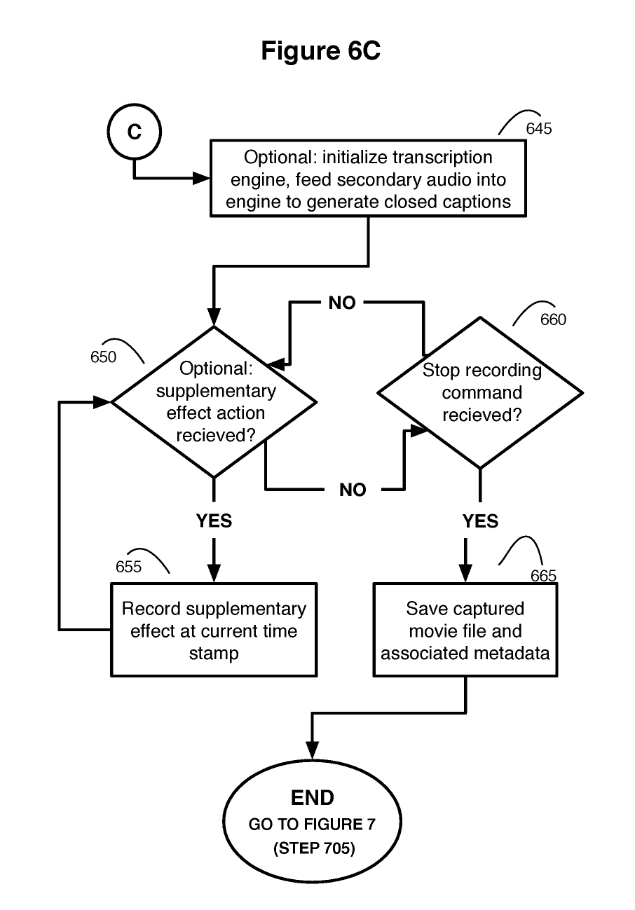

Returning to the discussion of step 415, if a new time stamp has not been sought, the method 400 may proceed to a step 425. At step 425, a determination may be made as to whether a command has been received to annotate. In one embodiment, annotation may refer to the introduction of secondary audiovisual media that is added, by way of example and not limitation, a user or other entity. In some examples, users may choose to ‘comment’ on the primary A/V by annotating as described herein. If an annotation command has been received, the method 400 may transition to method 600, proceeding to a step 605, described in more detail in FIG. 6. If an annotation command has not been recieved, the method 400 may proceed to a step 430.

At step 430, a determination may be made as to whether a command has been recieved to seek to a timestamp in a secondary A/V. If a command has been recieved to seek to a new timestamp in a secondary A/V, the method 400 may proceed to a step 435. At step 435, playback of a secondary A/V is sought to the selected timestamp.

If a command to seek to a timestamp in a secondary A/V has not been recieved, the method 400 may proceed to a step 440, in which a determination may be made as to whether a primary A/V is currently playing. If a primary A/V is not currently playing, the method 400 may continue to a step 445. If a primary A/V is currently playing, the method 400 may continue to a step 455.

At step 445, a determination may be made as to whether a play primary A/V command has been recieved. If a play primary A/V command has been recieved, the method 400 may proceed to a step 450, wherein playback of the primary A/V, in some embodiments, may begin or may continue, after which the method 400 may continue to step 455. If a play primary A/V command has not been recieved, the method 400 may return to step 415.

At step 455, a determination may be made as to whether a stop primary A/V command has been recieved. If a stop primary A/V command has been recieved, the method 400 may proceed to a step 460. At step 460, which playback of a primary A/V is ceased, after which the method 400 may return to step 415. In one embodiment, a stop primary A/V command may be issued by a user. In another embodiment, a stop primary A/V command may be issued by a computer (e.g., when an annotation is scheduled on the timeline for playback or when a comment-in timestamp has been reached). If a stop primary A/V command has not been recieved, the method 400 may proceed to a step 465.

At a step 465 a determination may be made as to whether, during the current playback of primary A/V, a timestamp for a secondary A/V has been reached. In one embodiment, an annotation may be associated with a certain location on the timeline of the primary A/V. If no timestamp for a secondary A/V has been reached, the method 400 may return to step 415. If a timestamp for a secondary A/V has been reached, then the method 400 may proceed to a step 470.

At step 470, a determination may be made as to whether a synchronicity flag has been raised. If a synchronicity flag has not been raised, at a step 475, playback of the primary A/V may be paused, and the method 400 may end. In one embodiment, the method 400 may proceed to a step 505 in a method 500 described in FIG. 5.

If a synchronicity flag has been raised, at an optional step 480, a sound volume of some or all of the audio associated with a primary A/V may be lowered, and the method 400 may end. In one embodiment, the method 400 may proceed to a step 505 in a method 500 described in FIG. 5.

### FIGS. 5A, 5B and 5C: Secondary A/V Presentation Engine

FIGS. 5A, 5B and 5C illustrate a method for operation of a presentation engine that presents secondary audiovisual media, according to embodiments of the present disclosure. In some embodiments, the presentation engine may execute instructions for playback of audiovisual media. Although the method steps are described in conjunction with FIGS. 1-8, persons skilled in the art will understand that any system configured to perform the method steps, even in a different order may fall within the scope of the present disclosure. Moreover, the steps in this method are illustrative only and do not necessary need to be performed in the given order they are presented herein. In some embodiments, certain steps may be omitted completely.

In some embodiments, the method 500 may embody the steps in which playback of a secondary A/V occurs. In some embodiments, the method 500 may continue from other methods described herein. In one embodiment, the method 500 may continue from steps 475 or 480 from method 400, as described in FIG. 4.

The method 500 may begin with a step 505, in which a frame for secondary A/V playback is introduced. By way of example and not limitation, the frame may be ‘slid’ in an animated fashion onto the user's screen as an overlay. Furthering the example, the frame may partially or completely obscure the user's view of the primary A/V. While one example of secondary A/V playback is given, the inventors contemplate any and all methods of playback of A/V content. At a step 510, playback of a secondary A/V may be sought to the beginning of the secondary A/V file.

At a step 515, a determination may be made as to whether primary A/V is currently playing. If the primary A/V is currently playing, then the method 500 may proceed to a step 550. If the primary A/V is not currently playing, the method may proceed to a step 520.

At step 520, a determination may be made as to whether a command to edit a secondary A/V has been recieved. If a command to edit a secondary A/V has been recieved, in one embodiment, the method 500 may transition into method 400, proceeding to step 415 as described herein in FIG. 4. If a command to edit a secondary A/V has not been recieved, the method 500 may proceed to a step 525.

At step 525, a determination as to whether a skip command has been recieved. If a skip command has been recieved, the method 500 process to a step 530, wherein playback of a secondary A/V is sought to the end of the secondary A/V file, and the method 500 may proceed to a step 565. If a skip command has not been recieved, the method 500 may proceed to a step 535.

At a step 535, a determination may be made as to whether a secondary A/V is playing. If a secondary A/V is not playing, the method 500 may proceed to a step 540. If a secondary A/V is playing, the method 500 may proceed to a step 545.

At step 540, a determination as to whether a play command has been recieved. If a secondary A/V is playing, the method 500 may proceed to a step 550. If a secondary A/V is not playing, the method 500 may return to step 525.

At step 545, a determination as to whether a stop command has been recieved. If a stop command has been recieved, the method 500 may proceed to a step 555, wherein playback of a secondary A/V is ceased, and the method 500 may return to step 525. If a stop command has not been recieved, the method 500 may proceed to a step 560

At step 550, playback of a secondary A/V may begin. Optionally in this step, closed captions and/or supplementary effects described herein may occur, after which, the method 500 may return to step 545.

At step 560, a determination as to whether the secondary A/V has completed playback. If the secondary A/V has not completed playback, the method 500 may return to step 525. If the secondary A/V has completed playback, the method 500 may proceed to a step 565.

At step 565, secondary A/V playback may cease. In one embodiment, a transition may occur in order to demonstrate the handoff back to the primary video. By way of example and not limitation, a frame supporting the playback of a secondary A/V may be ‘slid’ out of view (i.e., “off” the user's screen). While one example of secondary A/V playback cessation is given, the inventors contemplate any and all methods of ceasing playback of A/V content.

At a step 570, a determination may be made as to whether a commentary synchronicity flag has been raised. If a commentary synchronicity flag has been raised, in one embodiment, the method 500 may transition into method 400, proceeding to step 415 as described in FIG. 4. If a commentary synchronicity flag has not been raised, the method 500 may proceed to a step 575.

At step 575, a determination may be made as to whether the secondary A/V was playing. If the secondary A/V was not playing, in one embodiment, the method 500 may transition into method 400, proceeding to step 415 as described herein in FIG. 4. If the secondary A/V was playing, the method 500 may end. In one embodiment, the method 500 may transition into method 400 and return to a step 450 as described in FIG. 4.

### FIGS. 6A, 6B and 6C: Secondary A/V Capture Engine

FIGS. 6A, 6B and 6C illustrate a method for operation a secondary audiovisual media capture engine, according to embodiments of the present disclosure. In some embodiments, the annotation engine may execute instructions for playback of audiovisual media. Although the method steps are described in conjunction with FIGS. 1-8, persons skilled in the art will understand that any system configured to perform the method steps, even in a different order may fall within the scope of the present disclosure. Moreover, the steps in this method are illustrative only and do not necessary need to be performed in the given order they are presented herein. In some embodiments, certain steps may be omitted completely.

The method 600 may begin at a step 605, in which a camera capture session may be initialized. In one embodiment, this session may represent a user recording an annotation. By way of example and not limitation, this camera may be the front-facing camera recording the user making commentary about a primary A/V, as described herein. In another embodiment, an optional step (not shown) of applying a user signature or other indication of authorship may be executed. While some examples provided herein describe one user, the inventors envision primary A/V being annotated (e.g., with secondary A/V) from multiple users.

At a step 610, a live preview of the camera capture session may be provided. In one embodiment, this preview may be overlaid on the primary video frame. At an optional step 615, an image filter may be applied to the live preview.

At a step 620, a determination may be made as to whether a change filter command has been recieved. If a change filter command has been recieved, the method 600 may return to step 615. If a change filter command has not been recieved, the the method 600 may proceed to a step 625.

At step 625, a determination may be made as to whether a command to change the secondary video frame position has been recieved. If a command to change the secondary video frame position has been recieved, the method 600 may proceed to a step 630 wherein the live video preview frame position is updated, after which the method 600 proceeds to a step 645. If a command to change the secondary video frame position has not been recieved, the method 600 may proceed to a step 635.

At step 635, a determination may be made as to whether a start recording command has been recieved. If a start recording command has not been recieved, the method 600 may return to step 620. If a start recording command has been recieved, the method 600 may proceed to step 636.

At step 636, a determination may be made as to whether a synchronicity flag has been raised. If a synchronicity flag has been raised, the method proceeds to a step 638 in which playback of a primary A/V may begin, after which the method 600 proceeds to a step 640. If a synchronicity flag has not been raised, the method 600 proceeds to step 640. In one embodiment, when streaming a primary A/V, an additional step (not shown) may be executed that may allow for the buffering of a sufficient time range of primary A/V on a user device for playback before beginning the capture process. Buffering in this manner may facilitate allowing primary A/V to be playable simultaneously with a secondary A/V preview (e.g., live camera capture preview) with reduced lag. The inventors envision an embodiment in which the record button may be disabled until the primary A/V is buffered sufficiently if a synchronicity flag has been raised, or a ‘buffering video’ indicator populates on the user's device in order to allow for synchronous primary A/V playback alongside the the live preview of secondary A/V.

At step 640, capture of A/V content from a camera may begin, and A/V output may be saved to file. At an optional step 645, a transcription engine may be initialized, and audio from secondary A/V may be fed into the transcription engine to begin generating closed captions. In some embodiments, primary A/V may continue playing in the background.

At an optional step 650, a determination as to whether an ‘apply supplementary effect’ command has been recieved. If an ‘apply supplementary effect’ command has been recieved, the method 600 may proceed to a step 660 in which a supplementary effect may be recorded at the current time stamp, after which the method 600 may return to step 650. By way of example and not limitation, a supplementary effect may be a digital pen stroke, insertion of an animated sticker, or any effect described herein. The inventors contemplate any and all forms of animations or effects that are used in A/V content as known in the art. If an ‘apply supplementary effect’ command not has been recieved, the method 600 may proceed to a step 660.

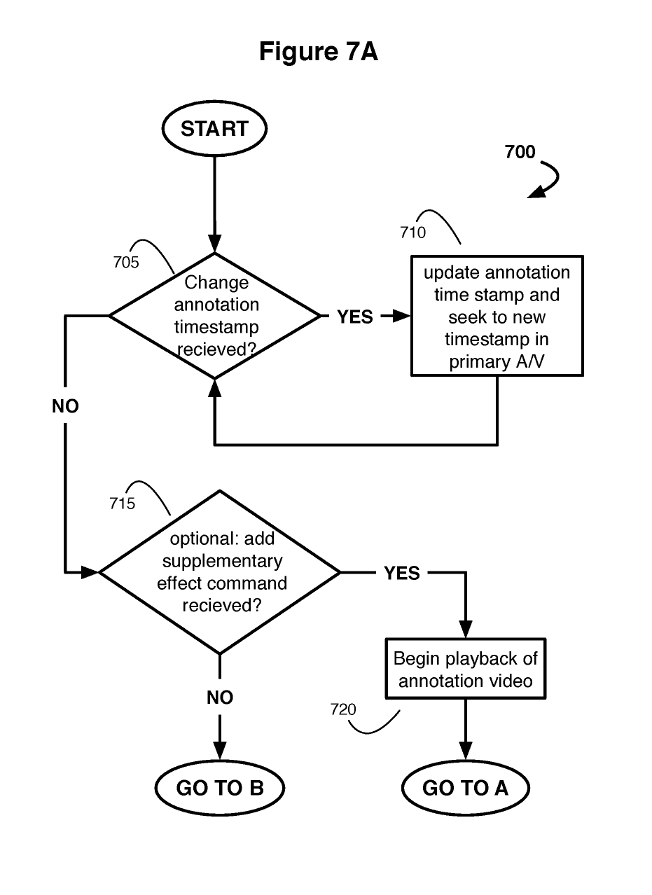

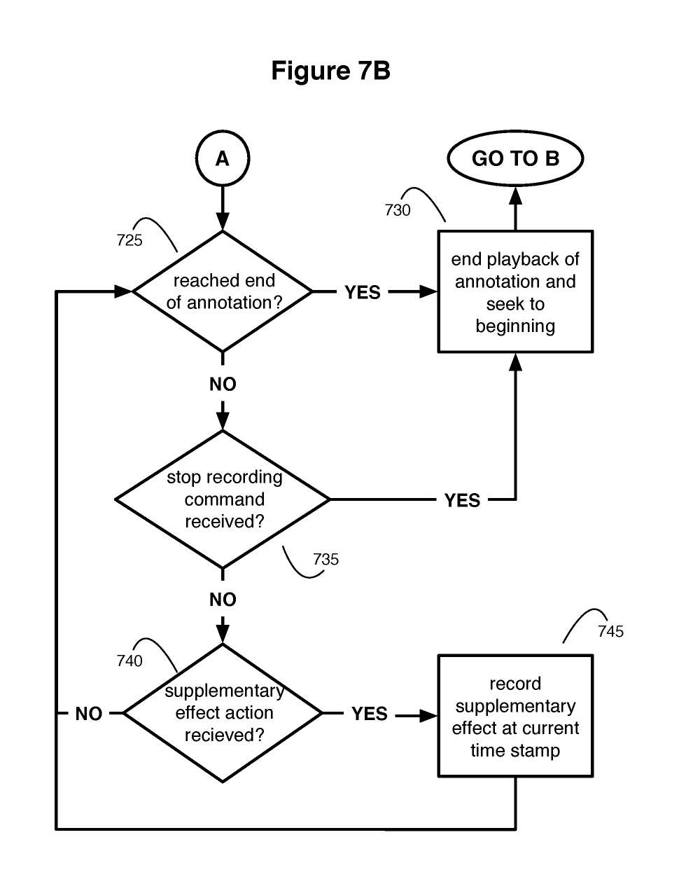

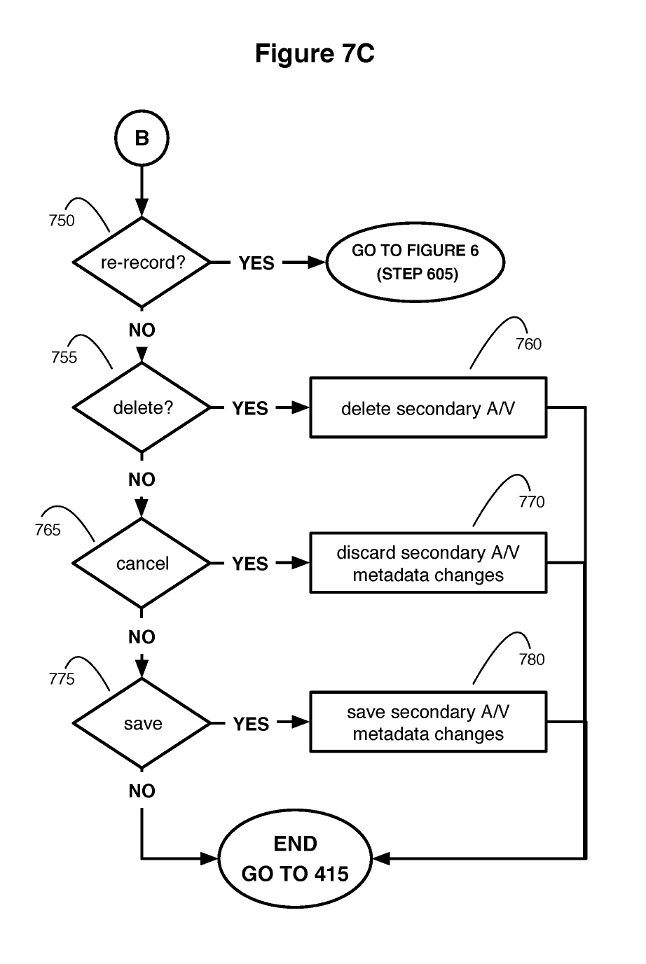

At step 660, a determination as to whether a ‘stop recording’ command has been recieved. If a ‘stop recording’ command has not been recieved, the method 600 may return to step 650. If a ‘stop recording’ command has been recieved, the method may proceed to a step 665, wherein the captured movie file and associated metadata may be saved to file. After which, the method 600. In some embodiments, the method 600 may proceed to other methods described herein. In one embodiment, the method 600 may transition to method 700 and begin at step 705, as described in FIG. 7.

### FIGS. 7A, 7B and 7C: Secondary A/V Editing Engine

FIGS. 7A, 7B and 7C illustrate a method for operation of a secondary audiovisual media editing engine, according to embodiments of the present disclosure. In some embodiments, the secondary audiovisual media editing engine may allow for editing of secondary A/V as well as metadata associated with the primary and secondary A/V. Although the method steps are described in conjunction with FIGS. 1-8, persons skilled in the art will understand that any system configured to perform the method steps, even in a different order may fall within the scope of the present disclosure. Moreover, the steps in this method are illustrative only and do not necessary need to be performed in the given order they are presented herein. In some embodiments, certain steps may be omitted completely.

The method 700 may begin at a step 705, in which a determination may be made as to whether a ‘change annotation timestamp’ command has been recieved. If a ‘change annotation timestamp’ has been recieved, at a step 710, a secondary A/V timestamp may be updated and playback is sought to a new timestamp in the primary A/V. In this manner, secondary A/V metadata is edited to reflect the new timestamp. In some embodiments, the start time of an existing annotation may be changed without necessitating recomposition of a video file containing one or more of each primary and/or secondary A/V. Thus, in this manner, playback of a combination of one or more primary and/or secondary A/V may be achieved without computationally expensive video compositing. Returning to execution of method 700, if a ‘change annotation timestamp’ has not been recieved, the method 700 may proceed to a step 715.

In step 715, an optional determination may be made as to whether an ‘apply supplementary effect’ command has been recieved. If an ‘apply supplementary effect’ command has not been recieved, the method may proceed to a step 750, as described herein. If an ‘apply supplementary effect’ command has been recieved, then at a step 720, playback of a secondary A/V may begin and the method may proceed to a step 725.

At a step 725, a determination may be made as to whether the playback to the end of a secondary A/V has been reached. If playback to the end of a secondary A/V has been reached, the method may proceed to a step 730, in which playback of a secondary A/V may be ended and playback may be sought to the beginning, after which the method 700 process to a step 750, described in detail below. If playback to the end of a secondary A/V has not been reached, the method 700 may proceed to a step 735.

In step 735, a determination may be made as to whether a ‘stop recording’ command has been recieved. If a ‘stop recording’ command has been recieved, the method may proceed to step 730. If a ‘stop recording’ command has not been recieved the method may proceed to a step 740.

At step 740, a determination may be made as to whether a ‘supplementary effect’ action has been recieved. If a ‘supplementary effect’ action has not been recieved, the method 700 may return to step 725. If a ‘supplementary effect’ action has been recieved, the method may proceed to a step 745.

At step 745, a supplementary effect is recorded at the current timestamp. In some embodiments, supplementary effects may take the form of animations viewable on secondary A/V. By way of example and not limitation, a supplementary effect may be a digital pen stroke or insertion of an animated sticker or any effect described herein. While a few examples have been provided here, the inventors contemplate the addition of any secondary A/V known in the art as a supplementary effect that may be added in this step.

At step 750, a determination may be made as to whether a re-record command has been recieved. If a re-record command has been recieved, the method 700 may end. In one embodiment, the method 700 may transition to method 600 to step 605 in FIG. 6, as described herein. If a re-record command has not been recieved, the method may proceed to a step 755.

At step 755, a determination may be made as to whether a delete command was recieved. If a delete command was recieved, the method may proceed to a step 760 in which the secondary A/V may be deleted and/or removed from the project file, after which the method 700 may end. In some embodiments, the method 700 transitions to method 400 and may proceed to step 415 as described in FIG. 4. If a delete command was not recieved, the method 700 may proceed to step 765.

At step 765, a determination may be made as to whether a cancel command was recieved. If a cancel command was recieved, at a step 770, changes to the secondary A/V metadata may be discarded, after which the method 700 may end. In some embodiments, the method 700 transitions to method 400 and may proceed to step 415 as described in FIG. 4. If a cancel command was not recieved, the method 700 may proceed to a step 775.

At step 775, a determination may be made as to whether a save command has been recieved. If a save command has been recieved, at a step 780, one or more changes to the secondary A/V metadata may be saved, after which the method 700 may end. In some embodiments, the method 700 transitions to method 400 and may proceed to step 415 as described in FIG. 4. If a save command has not been recieved, the method 700 may end. In some embodiments, the method may return to step 705.

In some embodiments, a user may have the option to share a project file publicly. In one embodiment, one or more associated primary and secondary A/V may be composited into a single video file or collection of related video files that may, in a further embodiment, include supplementary data. These files may be uploaded onto the Internet for others to view.

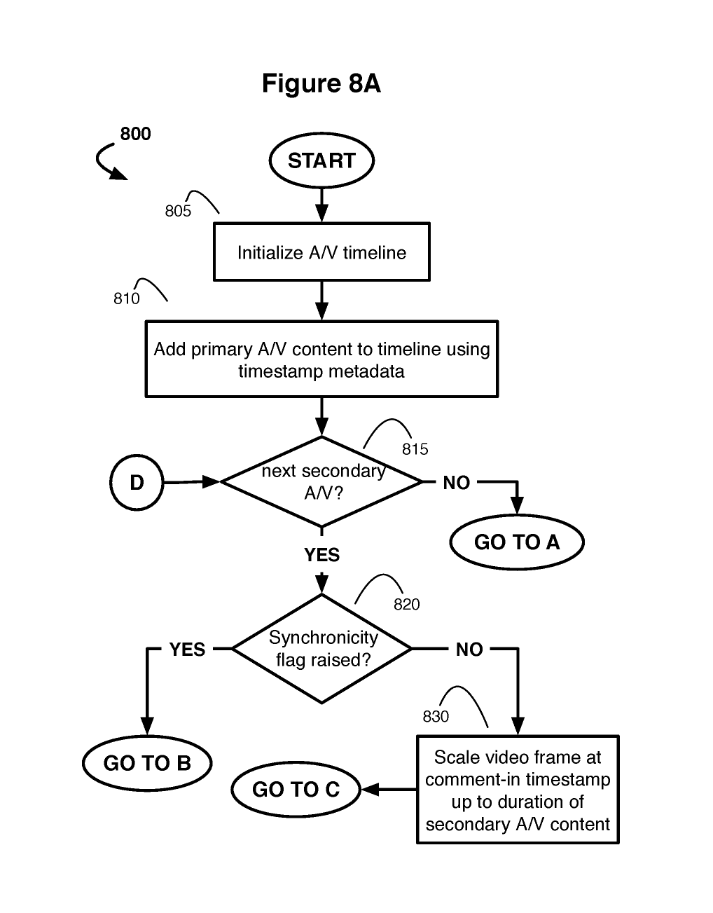

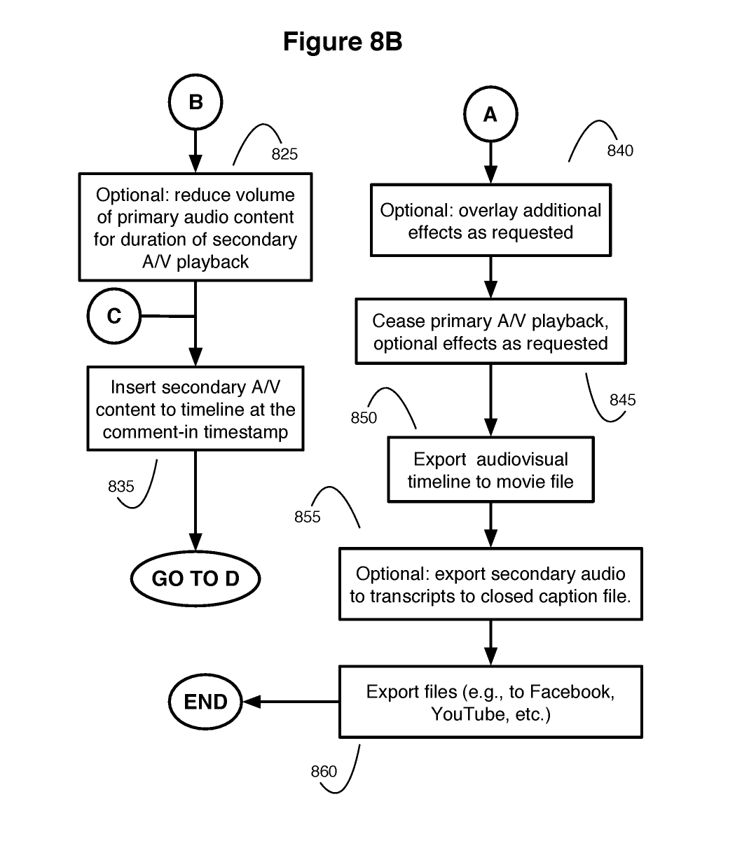

### FIGS. 8A and 8B: A/V Compositing Engine

FIGS. 8A and 8B illustrate a method for operation of a audiovisual media composition engine, according to embodiments of the present disclosure. In some embodiments, the audiovisual media composition engine may composite one or more of the following from a project file: at least one primary A/V, at least one secondary A/V, metadata, and supplementary effects as described herein. Although the method steps are described in conjunction with FIGS. 1-8, persons skilled in the art will understand that any system configured to perform the method steps, even in a different order may fall within the scope of the present disclosure. Moreover, the steps in this method are illustrative only and do not necessary need to be performed in the given order they are presented herein. In some embodiments, certain steps may be omitted completely.

The method 800 may begin at a step 805 in which a timeline may be initialized. In one embodiment, this timeline may be a new, empty timeline representing a new project file. At a step 810, one or more primary A/V content may be added to the timeline. In one embodiment, the primary A/V may include metadata in the form of timestamps as described herein. In this embodiment, the primary A/V may be attached to the timeline based on a video-in and a video-out timestamps.

At a step 815, a determination may be made as to whether a secondary A/V content may be added. If a secondary A/V content is to be added, the method 800 proceeds to a step 820. If no more secondary A/V content is to be added, the method 800 proceeds to a step 840.

At step 820, a determination may be made as to whether a synchronicity flag has been raised. If a synchronicity flag has been raised, the method 800 may proceed to a step 825. If a synchronicity flag has not been raised, the method 800 may proceed to a step 830.

At optional step 825, the volume of a primary A/V is reduced. In one embodiment, the volume of the primary A/V is reduced for at least the duration of the current secondary A/V. This volume reduction may be determined based on metadata associated with the secondary A/V, e.g., comment-in and comment-out timestamps. In another embodiment, the volume of the primary A/V may be increased or restored to a previous level after the duration of the secondary A/V.

At step 830, a video frame may be scaled. In one embodiment, the video frame scaling may occur at a comment-in timestamp, and may scale for the duration of the secondary A/V. In one embodiment, the video may appear paused at that frame for the duration of the secondary A/V.

At a step 835, secondary A/V may be inserted into a timeline. In one embodiment, secondary A/V may be inserted at a comment-in timestamp. In a further embodiment, the secondary A/V may be introduced with animations and/or effects described herein, including but not limited to: sliding animations and/or visual filters.

At step 840, additional effects may be applied to the audiovisual timeline. In one embodiment, these additional effects may be chosen or recorded by a user. These additional effects may include one or more of the following but not limited to: stickers, emoji, animations or drawings or any effect described herein. This list of additional effects is by no means exhaustive; the inventors contemplate any and all effects known in the art.

At an optional step 845, primary A/V content may undergo a transition. In one embodiment, this transition may represent cessation of playback. By way of example and not limitation, this cessation of playback may take the form of ‘fading out’ and being replaced by a brand logo, or any effect described herein, and the inventors contemplate any and all A/V transitions known in the art.

At a step 850, a timeline may be exported to a movie file. In one embodiment, this timeline may be the compilation of one or more of the following: primary A/V, secondary A/V, visual effects or any A/V described herein. By way of example and not limitation, this timeline may be a single primary A/V content and one or more secondary A/V content, wherein the primary A/V content is public A/V (e.g., on YouTube™) and the one or more secondary A/V content may be a user's video commentary (i.e., annotations) that display the user's reactions to the statements or other content within the primary A/V.

Furthering this example, the secondary A/V may be temporally placed (i.e., “timed”) such that when a second user views the primary video, secondary A/V appears to be triggered when the first user desires the secondary A/V to play in relation to the primary A/V. In this manner, this second user may view the primary A/V and become aware of the first user's thoughts and opinions on the primary A/V (via the secondary A/V) in real time. In an additional embodiment, this exporting process may represent a conversion (e.g., software-enabled A/V compression/compilation) of one or more A/V content and/or effects into a single A/V file (e.g., .mpeg, .avi, .mov, .mp4, mp3, .ogg, .wav or any audio or video file known in the art).

At an optional step 855, secondary audio may be exported to a transcription engine as described herein to create a closed caption file. At a step 860, the files may be exported to a third party website (e.g., Facebook™, YouTube™, etc.)

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

We claim:

1. A method for creating an audiovisual media project, the method comprising:
creating a project file;
recalling a primary A/V;
capturing a secondary A/V with a recording device;
tracking a secondary metadata associated with the secondary A/V media; and,
storing the secondary A/V in a non-transitory memory.

2. The method of claim 1, wherein the secondary metadata is further associated with the primary A/V.

3. The method of claim 2, further comprising the steps of:
applying a supplemental effect to the secondary A/V.

5. The method of claim 1, further including the step of:
playing back of the primary A/V,
wherein the capturing occurs during playback of the primary A/V.

6. The method of claim 1, further including the steps of:
playing back of the primary A/V; and
ceasing playback of the primary A/V,
wherein the capturing occurs during the cessation of the primary A/V.

7. The method of claim 1, further including the steps of:
displaying the primary A/V; and,
presenting a live feed of the secondary A/V,
wherein the live feed of the secondary A/V represents an output of the capturing of the secondary A/V.

8. The method of claim 8, wherein the live feed of the secondary A/V is presented as an overlay on the display of the primary A/V.

9. The method of claim 8, wherein an audio volume of the primary A/V is modified during presentation of the live feed of the secondary A/V.

10. The method of claim 1, further including the steps of:
ceasing capture of the secondary A/V;
updating the secondary metadata with at least one comment-in timestamp and at least one comment-out timestamp,
wherein the comment-in timestamp is associated with a start time of capture of the secondary A/V, and
wherein the comment-out timestamp is associated with a stop time of capture of the secondary A/V.

12. A method comprising:
editing a secondary A/V;
editing a secondary metadata, wherein the secondary metadata is associated with the secondary A/V.

13. The method of claim 12, wherein the secondary metadata is associated with at least one comment-in timestamp and at least one comment-out timestamp.

14. The method of claim 13, wherein editing the secondary metadata further comprises the steps of:
modifying the at least one comment-in timestamp.

15. The method of claim 13, wherein editing the secondary metadata further comprises the steps of:
modifying the at least one comment-out timestamp.

16. The method of claim 13, wherein the secondary metadata is further associated with at least one supplemental effect.

17. The method of claim 16, further comprising the steps of:
modifying the at least one supplemental effect.

18. A method comprising:
recalling a primary A/V;
recalling at least one secondary A/V;
recalling at least one secondary metadata, wherein at least one secondary metadata is associated with the at least one secondary A/V; and,
compositing the primary A/V with the at least one secondary A/V, wherein the compositing occurs based on the at least one secondary metadata.

19. The method of claim 18,
wherein the at least one secondary metadata includes at least one comment-in timestamp and at least one comment-out timestamp,
wherein the compositing further includes the steps of:
associating a begin playback time of the at least one secondary A/V with the at least one comment-in timestamps; and,
associating a cease playback time of the at least one secondary A/V with the at least one comment-out timestamps.

20. The method of claim 19, further comprising the steps of:
exporting the primary A/V and the at least one secondary A/V as an A/V file.
